(19) United States
(12) Patent Application Publication
(10) Pub. No.: US 2014/0306976 A1
(43) Pub. Date: Oct. 16, 2014

(54) DISPLAY CONTROL DEVICE, DISPLAY CONTROL METHOD, AND PROGRAM

(71) Applicant: Sony Corporation, Tokyo (JP)

(72) Inventors: Shunichi Sugiura, Nagano (JP); Toru Iwamoto, Tokyo (JP); Aya Takechi, Tokyo (JP)

(73) Assignee: SONY CORPORATION, Tokyo (JP)

(21) Appl. No.: 14/360,344

(22) PCT Filed: Oct. 10, 2012
(86) PCT No.: PCT/JP2012/006488

§ 371 Date: May 23, 2014

(30) Foreign Application Priority Data
Dec. 2, 2011 (JP) 2011-265123

(51) Int. Cl. G06T 1/60

(52) U.S. Cl. CPC G06T 1/60
USPC 345/530

(57) ABSTRACT

An information processing apparatus includes: memory configured to store local data associated with content and to store network data associated with the content, wherein the local data comprises real data associated with the content, and wherein the network data comprises metadata associated with the content; and a display control unit configured to control display of the local data and the network data on a display unit based on time information associated with the network data and the local data.

### TECHNICAL FIELD

The present disclosure relates to a display control device, a display control method, and a program.

### BACKGROUND ART

In recent years, in addition to note-type computers (hereinafter, referred to as note PCs), small equipment such as cellular phones and game equipment are also loaded with various functions. In particular, for example, not only a communication function and a telephone conversation function but also various functions such as an e-mail function, an imaging function, and schedule management function are loaded. It is necessary for a user of such equipment to start and carry out an application corresponding to each function, and troubles are taken such that the user first returns to a menu screen and switches to a screen on which content of interest is to be selected when different contents are used.

In this regard, a display interface capable of comparing and contrasting plural kinds of data using time information as a key is disclosed in Patent Literature 1 as below.

### CITATION LIST

### Patent Literature

[PTL 1]JP 2009-48311A

### SUMMARY

### Technical Problem

However, in the technique disclosed in Patent Literature 1, the plural kinds of data stored in a storage device, that is, local data, are listed and displayed. Accordingly, when data (content) provided on a network as a network service is displayed, time and effort are taken because it is necessary to start a dedicated application again and then access the content.

In addition, in the technique of listing and displaying the local data, time is taken to display the content because real data of the content of interest is displayed after the real data is locally downloaded from the network by starting up the dedicated application.

Therefore, the present disclosure proposes an information processing device, a display control method, and a program that are novel and improved by enabling network data and local data to be centrally managed by virtue of display control based on the network data and the local data.

### Solution to Problem

In one illustrative embodiment, an information processing apparatus includes: memory configured to store local data associated with content and to store network data associated with the content, wherein the local data includes real data associated with the content, and wherein the network data includes metadata associated with the content; and a display control unit configured to control display of the local data and the network data on a display unit based on time information associated with the network data and the local data.

### BRIEF DESCRIPTION OF DRAWINGS

FIG. 1 is a diagram illustrating an outline of a display system in accordance with an embodiment of the present disclosure.

FIG. 2 is a block diagram illustrating a configuration of an information processing device in accordance with an embodiment of the present disclosure.

FIG. 3 is a flowchart illustrating an operation process of an information processing device in accordance with an embodiment of the present disclosure.

FIG. 4 is a diagram illustrating an example of a display screen on which central management is carried out on local data/network data in accordance with a first embodiment of the present disclosure.

FIG. 5 is a diagram illustrating an example of a display screen including an icon indicating an NWS of a collection source in accordance with the first embodiment of the present disclosure.

FIG. 6 is a diagram illustrating access to a network service according to a user operation on a thumbnail image in accordance with the first embodiment of the present disclosure.

FIG. 7 is a diagram illustrating a case in which a reply on a displayed comment is sent in accordance with the first embodiment of the present disclosure.

FIG. 8 is a diagram illustrating an example of a display screen on which plural kinds of data are disposed on a time axis in accordance with a second embodiment of the present disclosure.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, the description is made in the following order. 1. Outline of display system according to an embodiment of the present disclosure

2. Configuration and operation of information processing device

3. Embodiments

3-1. First embodiment

3-2. Second embodiment

4. Conclusion

### 1. OUTLINE OF DISPLAY SYSTEM ACCORDING TO AN EMBODIMENT OF THE PRESENT DISCLOSURE

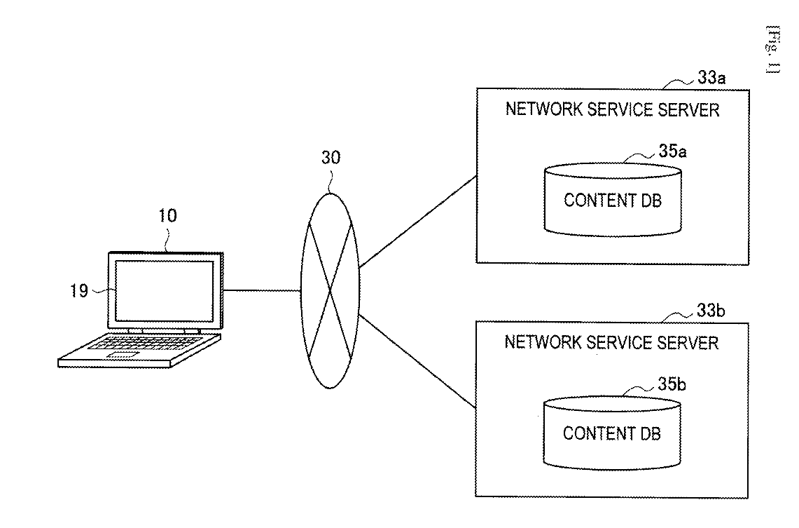

First, an outline of the display system according to an embodiment of the present disclosure will be described with reference to FIG. 1. As shown in FIG. 1, the display system according to an embodiment of the present disclosure includes an information processing device 10, a network 30, and network service servers 33a and 33b (hereinafter referred to as NWS servers 33a and 33b). In addition, hereinafter, when it is not necessary to discriminate between the NWS servers 33a and 33b, they will be referred to as the NWS server 33.

(NWS Server 33)

The NWS server 33 is a server that manages content and provides use of the content on the network. The content managed by the NWS server 33 includes, for example, photos, videos, sentences, music, games, and so forth.

In addition, the NWS servers 33a and 33b have content DBs 35a and 35b, respectively. In addition, hereinafter, when it is not necessary to discriminate between the content DBs 35a and 35b, they will be referred to as the content DB 35.

The content DB 35 stores real data of the content, and network data that is information associated with the content. In the present specification, the real data of the content is data of the content itself. For example, the real data of the content includes image data, text data, audio data, game programs, and so forth. In addition, in the present specification, the network data (information associated with the content) is metadata associated with the content. Specific examples of the metadata are as follows:

(A) a reduced content image (also referred to as a thumbnail image);

(B) Global Positioning System (GPS) information of the content;

(C) a content imaging time;

(D) a content upload time;

(E) text information posted on the content (also referred to as comments) and posting-user information; and

(F) information on the NWS server 33 managing the content.

Among the specific examples described above, the “(F) information on the NWS server 33 managing the content” includes access information for accessing the NWS server 33 such as a URL of the NWS server 33.

(Information Processing Device 10)

As shown in FIG. 1, the information processing device 10 connects to a plurality of the NWS servers 33 via the network 30, and collects network data stored in the content DB 35 from the NWS server 33 for each predetermined time interval.

The information processing device 10 of the present embodiment displays local data stored in the information processing device 10 and the network data collected from the NWS server 33 for each predetermined time interval on a display unit 19 in a time-series manner in accordance with time information associated with the respective data.

In addition, although a note PC is illustrated as the information processing device 10 in FIG. 1, the information processing device 10 of the present embodiment is not limited thereto. For example, smart phones, Personal Digital Assistants (PDA), cellular phones, portable music reproduction devices, portable video processing devices, or portable game apparatuses may be used.

### 2. CONFIGURATION AND OPERATION OF INFORMATION PROCESSING DEVICE

The outline of the display system according to the embodiment of the present disclosure has been described. Next, the configuration and operation process of the information processing device 10 included in the display system will be described.

### 2-1. Configuration

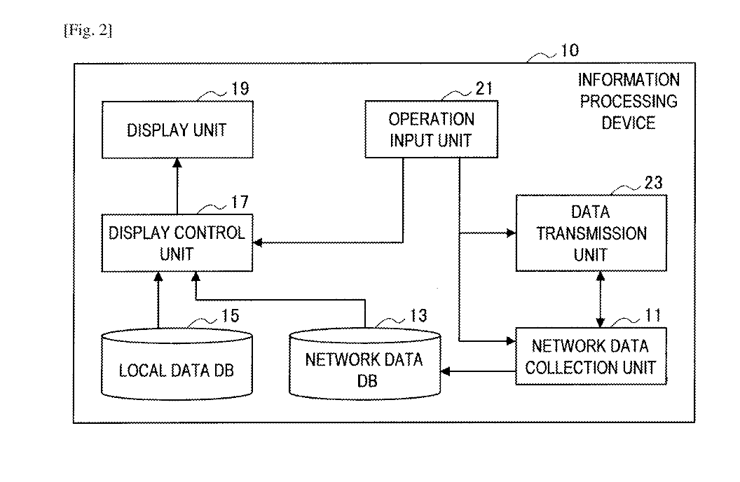

FIG. 2 is a block diagram illustrating the configuration of the information processing device 10 in accordance with the present embodiment. As shown in FIG. 2, the information processing device 10 includes a network data collection unit 11, a network data DB 13, a local data DB 15, a display control unit 17, a display unit 19, an operation input unit 21, and a data transmission unit 23. Hereinafter, each of the components will be described.

The network data collection unit 11 (hereinafter, also referred to as a data collection unit 11) collects the network data from the NWS server 33 via the network 30 for each predetermined time interval. In addition, from what NWS server the data collection unit 11 collects the network data is set in advance by the user. For example, the user selects an NWS to be used from a plurality of the network services (NWSs) listed on a screen that is set in advance (not shown), and sets an account to be used in such an NWS. The data collection unit 11 accesses the NWS server 33 of the NWS selected by the user for each predetermined time interval, and automatically collects the network data from the NWS server 33 using the set account.

In addition, the data collection unit 11 of the present embodiment may collect the real data of the content based on the access information included in the network data in accordance with a real data display operation from the user.

The network data DB 13 is a data holding unit that holds the network data (information associated with the content) collected by the data collection unit 11. The network data DB 13 includes a nonvolatile memory such as an HDD, or a volatile memory.

The local data DB 15 is a storage device that accumulates the local data within the information processing device 10. The local data in the present specification includes the real data of the content and metadata associated with the content.

Specific examples of the metadata stored in the local data DB 15 are as follows:

(a) a reduced content image (thumbnail image);

(b) content GPS information; and

(c) a content imaging time.

The display control unit 17 may carry out display control based on the local data stored in the local data DB 15 and the network data held in the network data DB 13, and may centrally manage the data.

In addition, aside from the thumbnail image of the content, a comment (e.g., text information) posted on the corresponding content may also be included in the network data. In this case, the display control unit 17 may display the thumbnail image of the local data, the thumbnail image of the content on the network, and a comment (text information) on the thumbnail image of the content on the corresponding network on one screen, and may centrally manage plural kinds of data.

In addition, the network data may be collected from the plurality of NWS servers 33 as described above, and the local data and the plural network data may be centrally managed.

In addition, the display control unit 17 may cause the local data and the network data to be disposed (disposed in a time-series manner) in a position on a time axis corresponding to time information associated with the respective data and to be displayed. In addition, the specific display control by the display control unit 17 of the present embodiment will be described in <3. Embodiments>.

The display unit 19 is a display module such as a Liquid Crystal Display (LCD), an Organic Light-Emitting Diode (OLED), a Cathode Ray Tube (CRT), or the like. For example, the display unit 19 of the present embodiment displays the display screen on which the local data and the network data are arranged in a time-series manner in response to control of the display control unit 17.

The operation input unit 21 includes input means for the user to input information such as a mouse, a keyboard, a touch panel, a button, a microphone, a switch, a lever, a remote controller, and so forth, and an input control circuit generating an input signal based on the input from the user and outputting the signal to the display control unit 17 or the like (CPU). The operation input unit 21 of the present embodiment detects a real data display operation, an upload operation, and a reply operation, and so forth, from the user.

The data transmission unit 23 transmits data via the network 30. The data transmission unit 23 of the present embodiment transmits the local data to the upload destination (e.g., NWS server 33) in accordance with the upload operation from the user. In addition, the data transmission unit 23 of the present embodiment transmits the reply data (comments or the like) to the reply destination (e.g., NWS server 33) in accordance with the reply operation from the user. In addition, the access information for accessing the upload destination or the reply destination is included in the network data held in the network data DB 13.

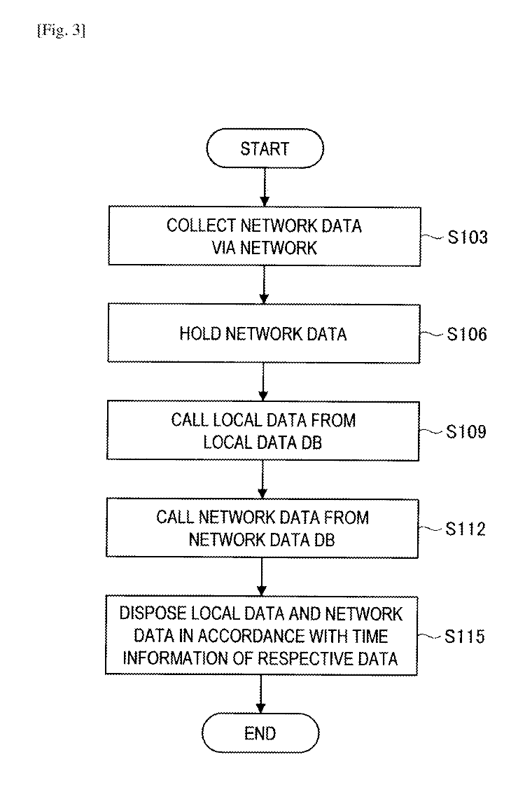

The configuration of the information processing device 10 according to the embodiment of the present disclosure has been described in detail. Next, the operation process of the information processing device 10 having the configuration described above will be described with reference to FIG. 3.

### 2-2. Operation Process

FIG. 3 is a flowchart illustrating the operation process of the information processing device 10 in accordance with the present embodiment. As shown in FIG. 3, in step S103, the data collection unit 11 first collects the network data from the NWS server 33 set in advance by the user via the network 30 for each predetermined time interval.

Next, in step S106, the network data DB 13 holds the network data collected by the data collection unit 11.

Next, in step S 109, the display control unit 17 calls the local data stored in the local data DB 15.

Next, in step S112, the display control unit 17 calls the network data held in the network data DB 13.

Next, in step S115, the display control unit 17 carries out the display control based on the local data and the network data. In particular, for example, the local data and the network data may be disposed in accordance with the time information associated with each of the local data and the network data.

### 3. EMBODIMENTS

As described above, the display control unit 17 of the present embodiment carries out the display control based on the local data and the network data. As described above, the network data is information associated with the content, and includes, for example, specific information based on contents open on the network such as a comment on the content posted by the user or another user, information on the posting user, and information on the time at which the content is uploaded. According to the present embodiment, the thumbnail image of the content on the network and the comment posted by the user are also displayed along with the local data, and it is thus possible to centrally manage the local/network data. Hereinafter, a plurality of embodiments centrally managing the local/network data will be particularly described.

### 3-1. First Embodiment

In the first embodiment, a specific example of centrally managing image data such as photos or videos stored in the local data DB 15 and image data such as photos or videos stored in the content DB 35 of the NWS server 33 will be described.

Here, the data collection unit 11 of the information processing device 10 accesses the NWS server 33 set in advance via the network 30, and collects the network data. The NWS server 33 may be identified by a network service in response to user selection of the network service. The network data includes a thumbnail image of the image data (content/real data) such as photos or videos, an imaging time of the image data, text information posted on the image data, and so forth. The network data collected by the data collection unit 11 is held in the network data DB 13.

In addition, in the present embodiment, the image data (content/real data), the thumbnail image of the image data, and the imaging time of the image data are stored in the local data DB 15.

Accordingly, the display control unit 17 centrally manages the local/network data by calling the thumbnail images from the local data DB 15 and the network data BB 13 and disposing the thumbnail images on the display screen.

(Grouping)

In the case of a large amount of the photos or videos that are to be managed, the display control unit 17 may carry out the management by grouping the thumbnail images based on the imaging time associated with the thumbnail image and then displaying each group (playlist) in the position on the time axis corresponding to the imaging time. Various grouping techniques are possible in the present embodiment, and some examples are listed below.

Grouping for each Event

The display control unit 17 carries out the grouping for each event based on the imaging date of the image data. For example, the thumbnail images may be grouped for each event based on a birthday, travel, and a wedding. The display control unit 17 may thus arrange and display each grouped playlist in a time-series manner in accordance with the date of each event along with the date and the event title such as “birthday,” “travel,” and “wedding.”

Grouping for each Month

The display control unit 17 carries out the grouping for each month of the same year based on the imaging date of the image data. For example, it is possible to group the thumbnail images for each of January, February, . . . , December of 2009. The display control unit 17 may also arrange and display the grouped playlists in a time-series manner.

Grouping for each Year /./

The display control unit 17 carries out the grouping for each year based on the imaging date of the image data. For example, it is possible to group the thumbnail images for each of 2008, 2009, and 2010. The display control unit 17 may also arrange and display the grouped playlists in a time-series manner.

In addition, displaying each playlist may denote displaying a plurality of thumbnail images included in the playlist in a matrix form, or may denote displaying a representative thumbnail images.

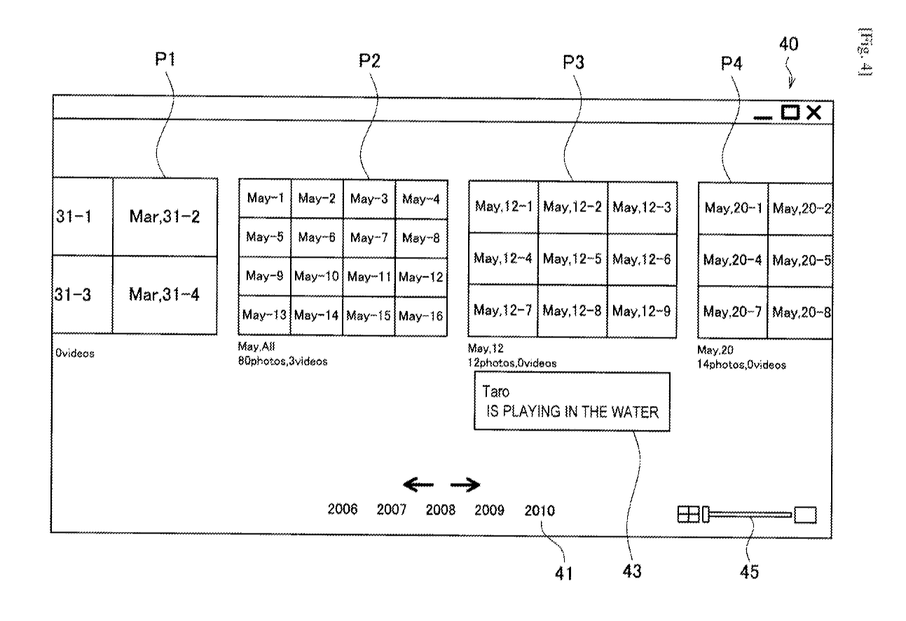

Hereinafter, the display screen on which the local/network data grouped based on the imaging time is centrally managed will be particularly described with reference to FIG. 4.

FIG. 4 is a diagram illustrating an example of the display screen on which the local/network data is centrally managed in accordance with the first embodiment.

On the display screen 40 shown in FIG. 4, playlists P1 to P4 grouped based on the imaging time of the respective image data are disposed in a horizontal direction. In the example illustrated in FIG. 4, playlists for each day of the month are sequentially arranged in a time-series manner across the playlist for each month. The user may scroll through the display screen horizontally to read the playlists of the previous month or the next month of the same year. In addition, when playlists of a different year are to be read, the user selects the year of interest from the year list 41 shown in FIG. 4.

In addition, as shown in FIG. 4, each of the playlists P1 to P4 displays a plurality of thumbnail images included in the playlist in a matrix form. The roughness of the matrix may be adjusted by the scroll bar 45 shown in FIG. 4.

In addition, the display control unit 17 may also display the display for identifying each of the playlists P1 to P4. For example, the playlist P2 is a playlist for each month including thumbnail images of the image data imaged in May, and displays “May, All” below the playlist P2 as shown in FIG. 4. On the other hand, the playlist P3 is a playlist for each day including thumbnail images of the image data imaged on May 12, and displays “May, 12” below the playlist P3 as shown in FIG. 4.

In addition, the display control unit 17 may also display the number of image data for each type included in the playlist P2. For example, the playlist P2 includes each thumbnail image of 80 photo data and 3 video data, and displays “80 photos, 3 videos” as shown in FIG. 4.

Further, in a case of the playlist including thumbnail images (network data) collected from the network, the display control unit 17 may also display comments posted on the image data. The number of comments to be displayed may be, for example, one, such as the representative comment 43 shown in FIG. 4.

(Display Indicating Network Service)

In addition, in the case of displaying the thumbnail images collected from the network, the display control unit 17 may also display the data collection source, that is, from what network service (NWS) the data is collected in the NWS server 33.

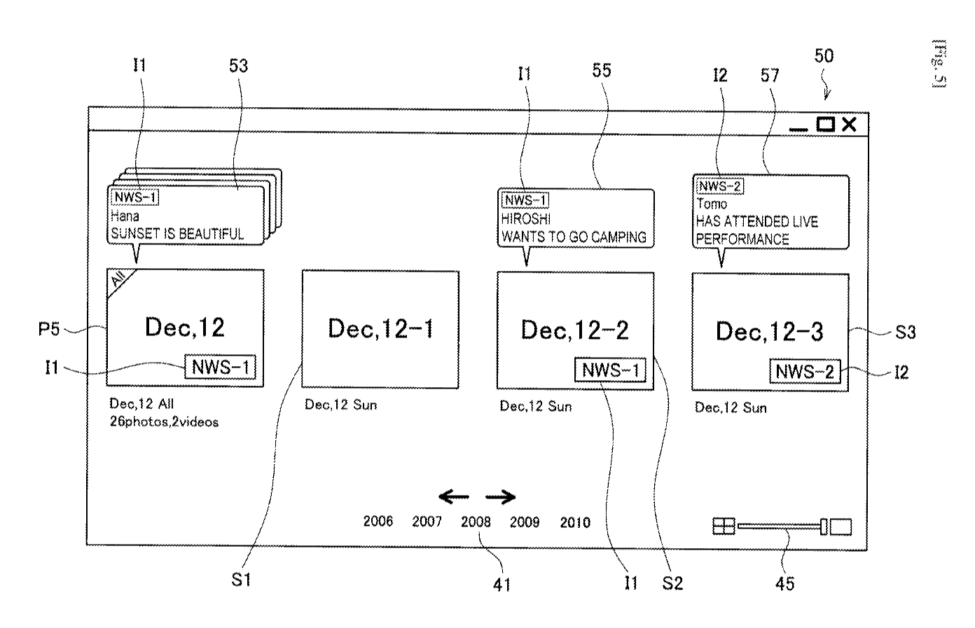

FIG. 5 is a diagram illustrating an example of the display screen including icons indicating the NWS of the collection source. In the display screen 50 shown in FIG. 5, thumbnail images S1 to S3 of the image data imaged on each day are sequentially arranged next to the playlist P5 for that day. The user may scroll through the display screen horizontally to browse through the thumbnail images of the previous day, the same day, and the next day.

Unlike the playlists P1 to P4 of FIG. 4, a representative thumbnail image and characters “All” on the upper left of the corresponding thumbnail image are displayed in the playlist P5 shown in FIG. 5. In addition, when a comment is posted on the thumbnail image displayed as a representative one, the comment 53 is displayed as shown in FIG. 5. In addition, when comments are posted on other thumbnail images, a plurality of comments may also be displayed after the comment 53 with overlapping as shown in FIG. 5.

Here, the thumbnail image S1 shown in FIG. 5 is a local thumbnail image called from the local data DB 15. In addition, the thumbnail images S2 and S3 are network data called from the network data DB 13.

When the network data such as the thumbnail images S2 and S3 are called from the network data DB 13 and displayed, the display control unit 17 also displays the data collection source, that is, from what NWS the data are collected.

For example, when the thumbnail image S2 is the network data collected from the NWS-1, the display control unit 17 displays the NWS icon I1 indicating “NWS-1” on the thumbnail image S2. In addition, even in the case of displaying the comment 55 on the image data, the NWS icon I1 is displayed as shown in FIG. 5. Although not shown in the figure, an icon may be provided that indicates that the data is local data.

In addition, when the thumbnail image S3 is the network data collected from the NWS-2, the display control unit 17 displays the NWS icon I2 indicating “NWS-2” on the thumbnail image S3. In addition, even in the case of displaying the comment 57 on the image data, the NWS icon I2 is displayed as shown in FIG. 5.

(Upload and Display Real Data)

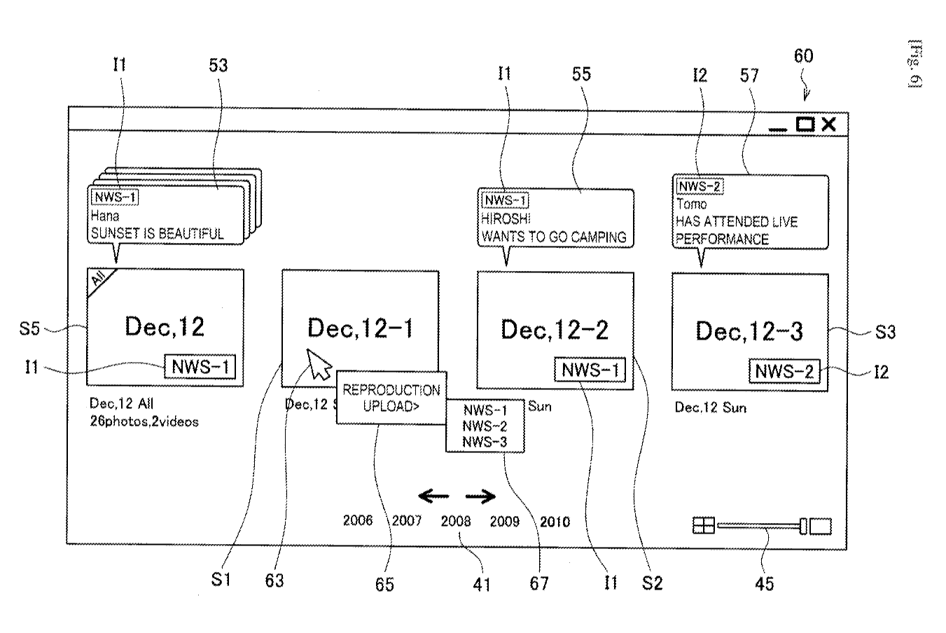

In addition, in the present embodiment, it is possible to access the network service in response to the user operation such that the real data of the displayed thumbnail image is collected from the network and displayed or the local data is uploaded to the NWS server 33 in response to the user operation. Hereinafter, description will be particularly made with reference to FIG. 6.

FIG. 6 is a diagram illustrating the access to the network service in response to the user operation on the displayed thumbnail image. As shown in the display screen 60 of FIG. 6, for example, the mouse pointer 63 is moved onto the thumbnail image S1 of the local data, which is then right-clicked to display the menu screen 65. An item “reproduction” for reproducing the original image data (real data/content) of the thumbnail image and an item “upload” for transmitting the original image data (real data/content) of the thumbnail image onto the network are displayed in the menu screen 65.

Upload Operation

When the user selects “Upload” in the menu screen 65, the upload destination selection screen 67 is displayed. When the user then selects the upload destination from the network service (e.g., NWS-1 to 3) items by which the upload may be carried out and displayed in the upload destination selection screen 67, the upload operation is detected by the operation input unit 21. The data transmission unit 23 then transmits the original image data (real data/content) of the thumbnail image S1 stored in the local data DB 15 to the NWS server 33 of the selected NWS in accordance with the upload operation detected by the operation input unit 21.

Real Data Display Operation

In addition, when “Reproduction” is selected from the menu screen 65 displayed by moving the mouse pointer 63 onto the thumbnail image S2 and then right-clicking it, the reproduction (real data display) operation is detected by the operation input unit 21. Here, the thumbnail image S2 is the network data held in the network data DB 13, and it is necessary to acquire the real data from the NWS server 33 in order to carry out the reproduction (real data display).

Accordingly, when the real data display operation of the network data is detected by the operation input unit 21, the data collection unit 11 accesses real data stored in the content DB 35 of the NWS server 33 and collects the real data based on the access information included in the network data held in the network data DB 13. The display control unit 17 then displays the real data collected by the data collection unit 11 (e.g., reproduces the video data).

(Reply Operation)

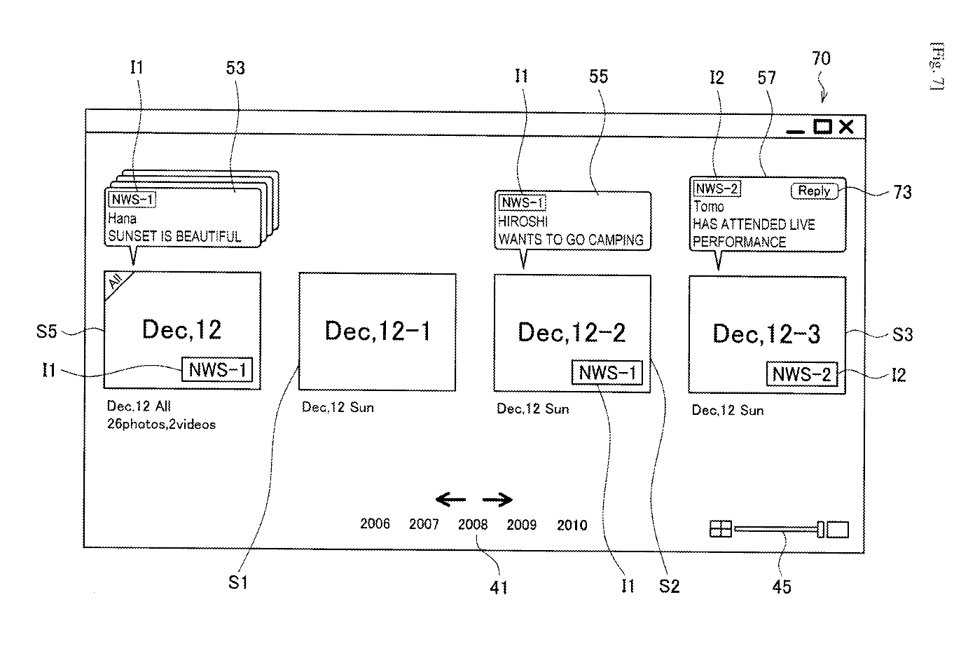

In addition, it is also possible to reply (respond) to the displayed comment in the present embodiment. For example, as shown in the display screen 70 of FIG. 7, the reply icon 73 is displayed on the comment 55 on which the reply operation may be carried out. When the user selects the reply icon 73, an input screen (not shown) for inputting reply contents is displayed, and the user inputs the reply comment. When the user carries out the operation to transmit the reply comment (e.g., selects a share button), the data transmission unit 23 transmits the reply comment. In addition, the access information on the transmission destination of the reply comment is included in the network data held in the network data DB 13.

### 3-2. Second Embodiment

Although the case of managing the image data of the video/photos has been described in the first embodiment, the local/network data that may be centrally managed in accordance with the present disclosure is not limited to the image data. For example, the local/network data that may be centrally managed may also be TV information, music, news, a schedule, and data of a product that will be or has been purchased.

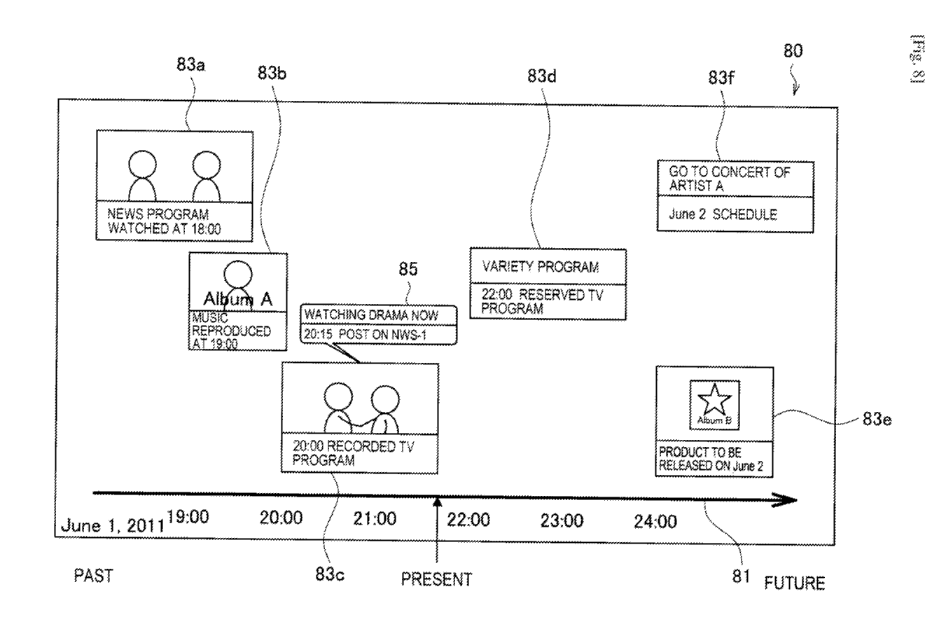

In the second embodiment, various data such as the TV information, the music, the news, the schedule, or the data of a product that will be or has been purchased is disposed in the position on the time axis corresponding to the time information associated with each of the various data so that the various data is centrally managed. For example, as shown in FIG. 8, the display control unit 17 according to the present embodiment displays the display screen 80 on which the thumbnail images 83a to 83e and the text information 85 based on each content are disposed in the position on the time axis 81 corresponding to the time information associated with each of the thumbnail images.

For example, the thumbnail images 83a, 83c, and 83d are based on the contents on which the TV programs are reproduced/recorded, and are displayed as images indicating the programs reproduced/recorded in the position on the time axis 81 in accordance with the reproduction/recording time. The thumbnail image 83b is based on the content on which music reproduction is carried out, and is displayed as the image indicating the music reproduced in the position on the time axis 81 in accordance with the music reproduction time.

The thumbnail image 83e is based on the content providing the purchase or purchase reservation service or the like on the product via the network, and is displayed as the image indicating the product to be purchased in the position on the time axis 81 in accordance with the scheduled date of purchase. The thumbnail image 83f is based on the content that manages the schedule, and is displayed as the image indicating the schedule contents in the position on the time axis 81 in accordance with the set schedule.

In addition, the text information 85 is based on the network service that is content sharing a short comment on the network, and is displayed as one indicating contents of the short comment in the position on the time axis 81 in accordance with the time posted by the user.

In addition, in order to prevent the unarranged screen from occurring, the user's preference may be analyzed from the operation log of the user, a priority may be given to each content, and the thumbnail image of the content having a high priority may be preferentially displayed. The operation log of the user is the log of information on TV programs that the user has watched or reserved, the number of reproductions of music data, the schedule contents, the purchase history of products, purchase reservations of products, and so forth.

In addition, the position (position in a vertical direction with respect to the time axis 81) or the size of the thumbnail image displayed on the display screen 80 may also be determined in accordance with the priority of each content.

In addition, recommendation information may be associated with the time information and displayed on the display screen 80 based on the analyzed user's preference. For example, the display control unit 17 may display the date on which advance reservation is initiated on the live performance of the user's favorite singer as the recommendation information.

### 4. CONCLUSION

As described above, in the display system of the present embodiment, it is possible to carry out the display control based on the local data stored in the local data DB 15 and the network data held in the network data DB 13 to centrally manage the local data and the network data. Therefore, it is possible to save the user trouble in managing the content of the local data and the network data, and the user can simply manage the content.

In addition, the network data that is information associated with the content is collected from the network for each predetermined time interval and then held in the network data DB 13 in the present embodiment. Accordingly, since the display control is carried out based on the local data and the held network data held in the present embodiment, it is not necessary to access the content (real data) again on the network at the time of carrying out the display control, and it is thus possible to speed up the display. In addition, it is thus possible to reduce the operation stress of the user.

In addition, the posted comments as well as the thumbnail images of the local data and the thumbnail images of the contents on the network may be displayed on one screen and totally and centrally managed in the present embodiment.

Further, aside from the image data, various contents such as TV information, music, news, a schedule, and a buying history may be centrally managed in the present embodiment.

It should be understood by those skilled in the art that various modifications, combinations, sub-combinations and alterations may occur depending on design requirements and other factors insofar as they are within the scope of the appended claims or the equivalents thereof.

In addition, the functions of the display control unit 17 described above may also be realized by the hardware configuration of the Central Processing Unit (CPU), the Read Only Memory (ROM), and the Random Access Memory (RAM). Additionally, the present technology may also be configured as below.
1. An information processing apparatus including: memory configured to store local data associated with content and to store network data associated with the content, wherein the local data includes real data associated with the content, and wherein the network data includes metadata associated with the content; and a display control unit configured to control display of the local data and the network data on a display unit based on time information associated with the network data and the local data.
2. The information processing apparatus of 1, wherein the memory includes a content database configured to store the local data associated with the content.
3. The information processing apparatus of 1, wherein the memory includes a network database configured to store the network data associated with the content.
4. The information processing apparatus of 3, wherein the network database is coupled to a social network.
5. The information processing apparatus of 1, further including a data collection unit configured to collect the network data from a server.
6. The information processing apparatus of 5, wherein the data collection unit is configured to collect the real data based on access information included in the network data.
7. The information processing apparatus of 5, wherein the server is identified by a network service in response to user selection of the network service.
8. The information processing apparatus of 1, wherein the real data includes at least one of: image data, text data, audio data, and a game program.
9. The information processing apparatus of 1, wherein the metadata associated with the content includes a reduced content image, GPS information, content imaging time, content upload time, text information posted about the content, and posting-user information.
10. The information processing apparatus of 9, wherein the text information includes a plurality of comments.
11. The information processing apparatus of 10, wherein the comments are displayed on the display unit such that a most recent comment appears to overlap less recent comments.
12. The information processing apparatus of 1, wherein the real data is a plurality of image files, the display control apparatus being configured to group the image files based on an image time associated with each image file.
13. The information processing apparatus of 1, wherein, in response to receiving an instruction to upload a file, the display control unit is configured to display a menu on the display unit, the menu providing a list of upload destinations for selection.
14. The information processing apparatus of 13, further including a data transmission unit, wherein, in response to receiving an upload destination selection, the data transmission unit transmits the local data or text data to a server corresponding to the upload destination selection.
15. The information processing apparatus of 14, wherein the network data includes access information that is used for accessing the server corresponding to the upload destination selection.
16. The information processing apparatus of 1, wherein the display control unit controls the display of the network data and the local data such that the network data and the local data are displayed in chronological order in one dimension based on the corresponding time information.
17. The information processing apparatus of 1, wherein the display control unit controls the display of the network data and the local data such that the network data and the local data are displayed in chronological order in two dimensions based on the corresponding time information.
18. The information processing apparatus of 1, wherein the display control unit provides an identifier for display with the local data and the network data, the identifier identifying whether the data is local data or network data.
19. A non-transitory computer readable medium for storing code that, when executed by a processor, causes the processor to: store local data associated with content in memory, wherein the local data includes real data associated with the content; store network data associated with the content in the memory, wherein the network data includes metadata associated with the content; and control display of the local data and the network data on a display unit based on time information associated with the network data and the local data.
20. A computer-implemented method for execution by a processor, the method including steps of: storing local data associated with content in memory, wherein the local data includes real data associated with the content; storing network data associated with the content in the memory, wherein the network data includes metadata associated with the content; and controlling display of the local data and the network data on a display unit based on time information associated with the network data and the local data.

### REFERENCE SIGNS LIST

10 Information processing device

11 Network data collection unit

13 Network data DB

15 Local data DB

17 Display control unit

19 Display unit

21 Operation input unit

23 Data transmission unit

30 Network

33, 33a, 33b Network service server (NWS server)

35, 35a, 35b Content DB

40, 50, 60, 70, 80 Display screen

43, 53, 55, 57 Comment

81 Time axis

P1 to P5 Playlist

I1, I2 NWS icon

S1 to S3 Thumbnail image

1. An information processing apparatus comprising:
memory configured to store local data associated with content and to store network data associated with the content, wherein the local data comprises real data associated with the content, and wherein the network data comprises metadata associated with the content; and
a display control unit configured to control display of the local data and the network data on a display unit based on time information associated with the network data and the local data.

2. The information processing apparatus of claim 1, wherein the memory comprises a content database configured to store the local data associated with the content.

3. The information processing apparatus of claim 1, wherein the memory comprises a network database configured to store the network data associated with the content.

4. The information processing apparatus of claim 3, wherein the network database is coupled to a social network.

5. The information processing apparatus of claim 1, further comprising a data collection unit configured to collect the network data from a server.

6. The information processing apparatus of claim 5, wherein the data collection unit is configured to collect the real data based on access information included in the network data.

7. The information processing apparatus of claim 5, wherein the server is identified by a network service in response to user selection of the network service.

8. The information processing apparatus of claim 1, wherein the real data comprises at least one of: image data, text data, audio data, and a game program.

9. The information processing apparatus of claim 1, wherein the metadata associated with the content comprises a reduced content image, GPS information, content imaging time, content upload time, text information posted about the content, and posting-user information.

10. The information processing apparatus of claim 9, wherein the text information comprises a plurality of comments.

11. The information processing apparatus of claim 10, wherein the comments are displayed on the display unit such that a most recent comment appears to overlap less recent comments.

12. The information processing apparatus of claim 1, wherein the real data is a plurality of image files, the display control apparatus being configured to group the image files based on an image time associated with each image file.

13. The information processing apparatus of claim 1, wherein, in response to receiving an instruction to upload a file, the display control unit is configured to display a menu on the display unit, the menu providing a list of upload destinations for selection.

14. The information processing apparatus of claim 13, further comprising a data transmission unit, wherein, in response to receiving an upload destination selection, the data transmission unit transmits the local data or text data to a server corresponding to the upload destination selection.

15. The information processing apparatus of claim 14, wherein the network data comprises access information that is used for accessing the server corresponding to the upload destination selection.

16. The information processing apparatus of claim 1, wherein the display control unit controls the display of the network data and the local data such that the network data and the local data are displayed in chronological order in one dimension based on the corresponding time information.

17. The information processing apparatus of claim 1, wherein the display control unit controls the display of the network data and the local data such that the network data and the local data are displayed in chronological order in two dimensions based on the corresponding time information.

18. The information processing apparatus of claim 1, wherein the display control unit provides an identifier for display with the local data and the network data, the identifier identifying whether the data is local data or network data.

19. A non-transitory computer readable medium for storing code that, when executed by a processor, causes the processor to:
store local data associated with content in memory, wherein the local data comprises real data associated with the content;
store network data associated with the content in the memory, wherein the network data comprises metadata associated with the content; and
control display of the local data and the network data on a display unit based on time information associated with the network data and the local data.

20. A computer-implemented method for execution by a processor, the method comprising steps of:
storing local data associated with content in memory, wherein the local data comprises real data associated with the content;
storing network data associated with the content in the memory, wherein the network data comprises metadata associated with the content; and
controlling display of the local data and the network data on a display unit based on time information associated with the network data and the local data.
